(19) United States
(12) Patent Application Publication
(10) Pub. No.: US 2013/0068080 A1
(43) Pub. Date: Mar. 21, 2013

(54) Cutting Tool Guide

(71) Applicants: John Holba, Naperville, IL (US); Chad Kean Richart, Cumming, GA (US)

(72) Inventors: John Holba, Naperville, IL (US); Chad Kean Richart, Cumming, GA (US)

(73) Assignees: Robert Bosch GmbH, Stuttgart (DE); Robert Bosch Tool Corporation, Broadview, IL (US)

(21) Appl. No.: 13/234,253

(22) Filed: Sep. 16, 2011

(51) Int. Cl. B26B 29/06

(52) U.S. Cl. 83/821

(57) ABSTRACT

A tool guide for guiding a cutting tool includes a cuff assembly, a first resilient clamp, and a second resilient clamp. The cuff assembly includes a body member, an arm member extending from the body member, and an opposing arm member extending from the body member. The body member, the arm member, and the opposing arm member are configured to define a workpiece channel. The first resilient clamp member is configured to extend from the arm member into the workpiece channel. The second resilient clamp member configured to extend from the opposing arm member into the workpiece channel.

### FIELD

This patent relates to a tool guide and in particular to a tool guide for guiding a cutting tool through a workpiece.

### BACKGROUND

Power saws are a type of cutting tool, which are useful for quickly and easily cutting material, such as construction lumber and other building products. A common type of power saw is a portable circular saw, which includes a foot plate and a circular saw blade that extends below the foot plate. Typically, a user cuts a workpiece with a circular saw by resting the foot plate on the workpiece, aligning the saw blade with a desired cut path, and then manually guiding the circular saw in the direction of the cut path, often following a marked line on the workpiece. However, the circular saw is movable along a path that deviates from the desired cut path, making the task of accurately guiding the circular saw difficult for some users.

Therefore, it is desirable to provide a tool guide, which simplifies the alignment and guiding of a circular saw through a workpiece.

### SUMMARY

According to one embodiment of the disclosure a tool guide for guiding a cutting tool includes a cuff assembly, a first resilient clamp, and a second resilient clamp. The cuff assembly includes a body member, an arm member extending from the body member, and an opposing arm member extending from the body member. The body member, the arm member, and the opposing arm member are configured to define a workpiece channel. The first resilient clamp member is configured to extend from the arm member into the workpiece channel. The second resilient clamp member is configured to extend from the opposing arm member into the workpiece channel.

According to another embodiment of the disclosure a tool guide for guiding a cutting tool relative to a workpiece includes a body member, an arm member, an opposing arm member, a first flange, and a second flange. The body member defines a first edge located in an edge plane. The arm member extends from the body member and defines a second edge located in the edge plane. The opposing arm member extends from the body member and defines a third edge located in the edge plane. The body member, the arm member, and the opposing arm member define a workpiece channel configured to receive the workpiece. The first flange extends away from the second edge. The second flange extends away from the third edge.

According to yet another embodiment of the disclosure a tool guide for guiding a cutting tool relative to a workpiece includes a body member, an arm member, an opposing arm member, a first flange, and a second flange. The arm member extends from the body member in a first direction. The opposing arm member extends from the body member in the first direction. The body member, the arm member, and the opposing arm member define a workpiece channel configured to receive the workpiece. The first flange extends from the arm member in a second direction. The second flange extends from the opposing arm member in a third direction opposite to the second direction.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a perspective view of a tool guide according to the disclosure;

FIG. 2 is a front elevational view of the tool guide of FIG. 1;

FIG. 3 is a top plan view of the tool guide of FIG. 1;

FIG. 4 is a bottom plan view of the tool guide of FIG. 1;

FIG. 5 is a cross sectional view taken along the line V-V of FIG. 3;

FIG. 6 is a cross sectional view taken along the line V-V of FIG. 3, showing the tool guide of FIG. 1 having received a workpiece;

FIG. 7 is a front elevational view of the tool guide of FIG. 1, showing the tool guide having received a workpiece and a portion of a cutting tool;

FIG. 8 is a perspective view of the tool guide of FIG. 1, showing the tool guide having received a workpiece and a cutting tool; and

FIG. 9 is a perspective view of another embodiment of the tool guide of FIG. 1, showing the tool guide having received a workpiece, a cutting tool, and a clamp device.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

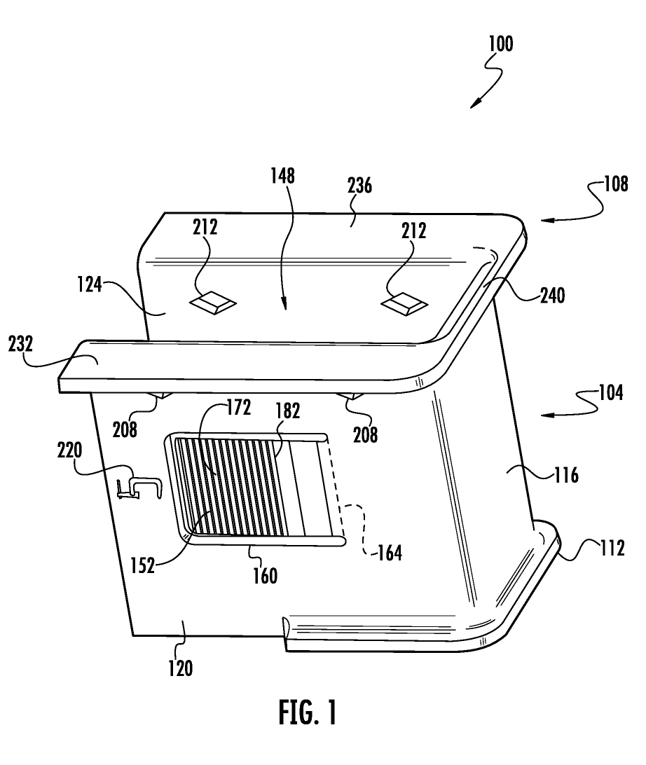

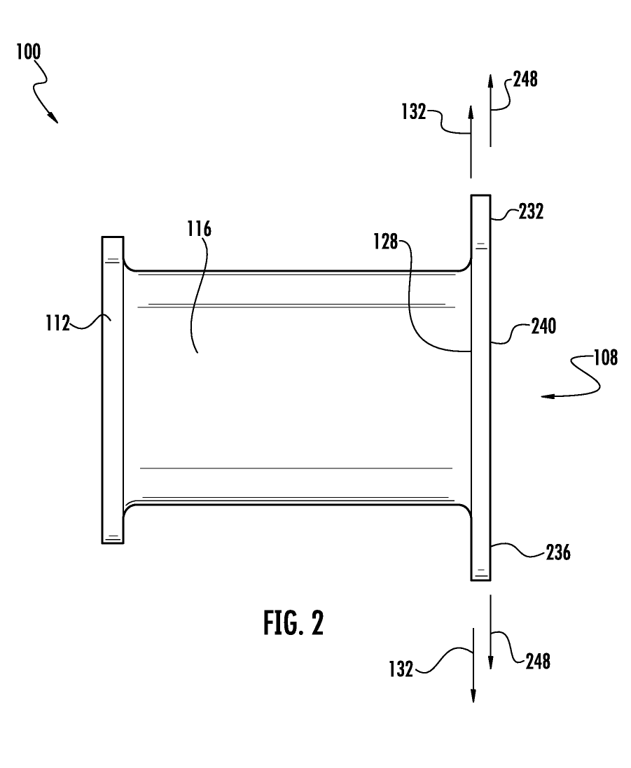

As shown in FIG. 1, a tool guide 100 includes a cuff assembly 104 positioned between a flange structure 108 and a support structure 112. The cuff assembly 104 includes a body member 116 positioned between an arm member 120 and an opposing arm member 124. As shown in FIG. 2, the body member 116 defines an edge 128, which is located in an edge plane 132.

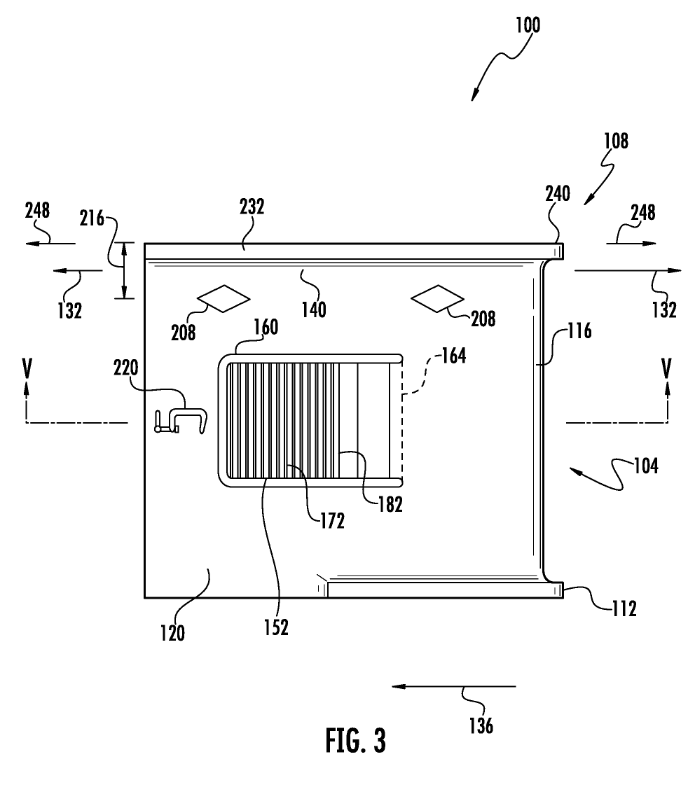

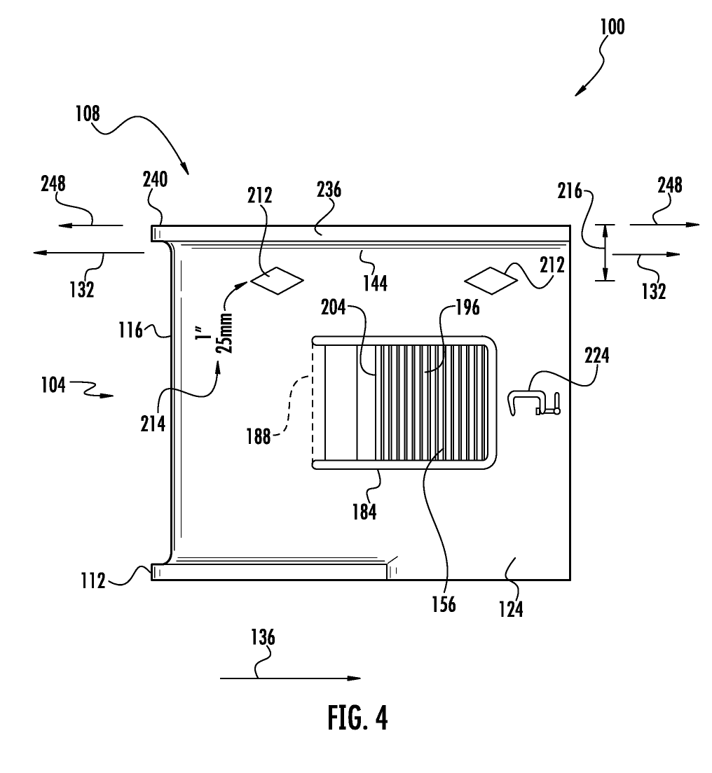

With reference to FIGS. 3 and 4, the arm members 120, 124 extend from the body member 116 in a direction 136 and include respective edges 140, 144, which are located in the edge plane 132. The arm members 120, 124 may be integrally formed with the body member 116, such that the tool guide 100 is a monolithic assembly.

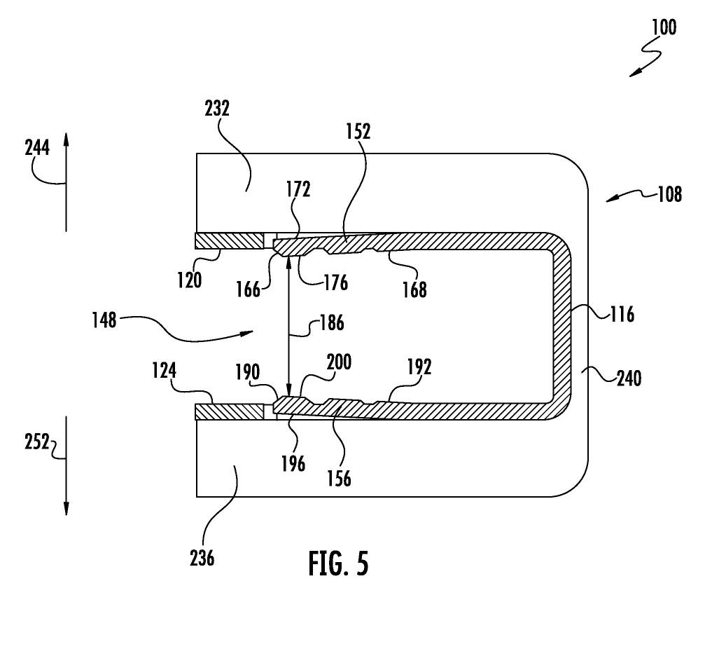

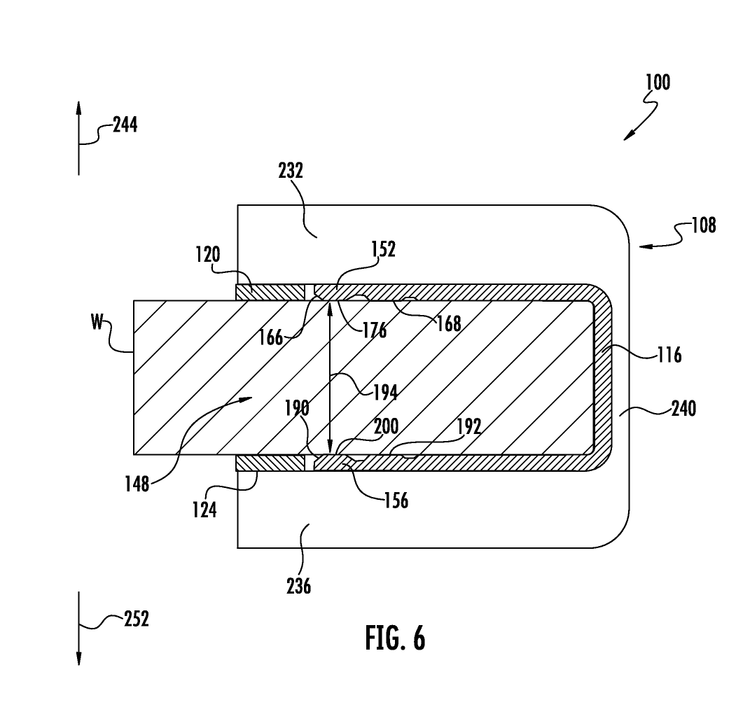

With reference to FIGS. 5 and 6, the body member 116, the arm member 120, and the opposing arm member 124 define a U-shaped workpiece channel 148 that is configured to receive a workpiece W. As shown in FIG. 6, the workpiece W is preferably positioned in the workpiece channel 148, in contact with the body member 116 and the arm members 120, 124 so that the tool guide 100 is stably supported on the workpiece.

In the illustrated embodiment, the cuff assembly 104 further includes a top clamp member 152 and a bottom clamp member 156. The top clamp member 152 is biased to extend from the arm member 120 toward the bottom clamp member 156 in the opposing arm member 124. The top clamp member 152 is situated in a U-shaped opening 160 (shown in FIGS. 1 and 3) in the arm member 120, with one side 164 of the top clamp member 152 united with the arm member 120. The top clamp member 152 is thus resiliently bendable about the side 164 between a relaxed position (shown in FIG. 5), in which a portion of the top clamp member 152 extends into the workpiece channel 148, and a clamped position (shown in FIG. 6). In the clamped position, the top clamp member 152 is moved away from the opposing arm member 124, such that a lesser portion or no portion of the top clamp member extends into the workpiece channel 148. The bottom clamp member 156 is similarly configured. In particular, the clamp member 156 is situated within an opening 184 in the arm member 124 and is resiliently bendable from a side 188 united with the arm member 124.

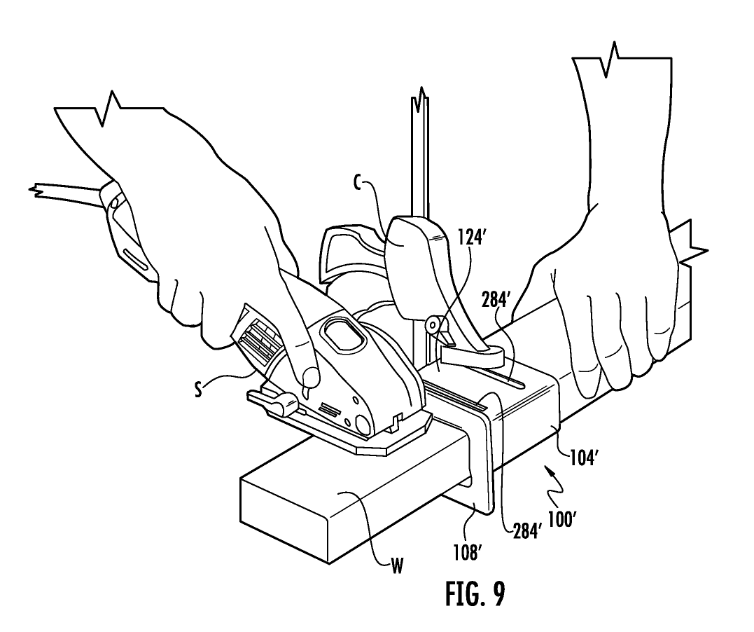

The top clamp member 152 includes a bevel surface 166, an inner ribbed surface 168 (FIG. 5), and an outer ribbed surface 172. The bottom clamp member 156 includes a bevel surface 190, an inner ribbed surface 192 (FIG. 5), and an outer ribbed surface 196 (FIG. 4). As shown in FIG. 5, the bevel surfaces 166, 190 are positioned at the end of the respective top and bottom clamp members 152, 156 facing each other across the channel 148. The inner ribbed surfaces 168, 192 are similarly positioned and may include numerous ribs 176, 200, which contact the workpiece W when the workpiece is positioned in the workpiece channel 148. As shown in FIGS. 3 and 4, the outer ribbed surfaces 172, 196 are positioned on an exterior side of the corresponding clamp members 152, 156 and include numerous ribs 182, 204, which provide a gripping surface for manual engagement or engagement with a separate clamp, such as the clamp C in FIG. 9. The outer ribbed surfaces 172, 196 may be gripped by a user to press the clamp members 152, 156 against the workpiece W to further stabilize the tool guide 100.

As shown in FIG. 5, in the relaxed position the clamp members 152, 156 are separated by a distance 186 that is narrower than the width of the channel 148, and narrower than the width of the workpiece W. In the clamped position, the clamp members 152, 156 are separated by the width 194 of the workpiece W, as shown in FIG. 6, but remain resiliently biased to clamp the workpiece within the channel 148.

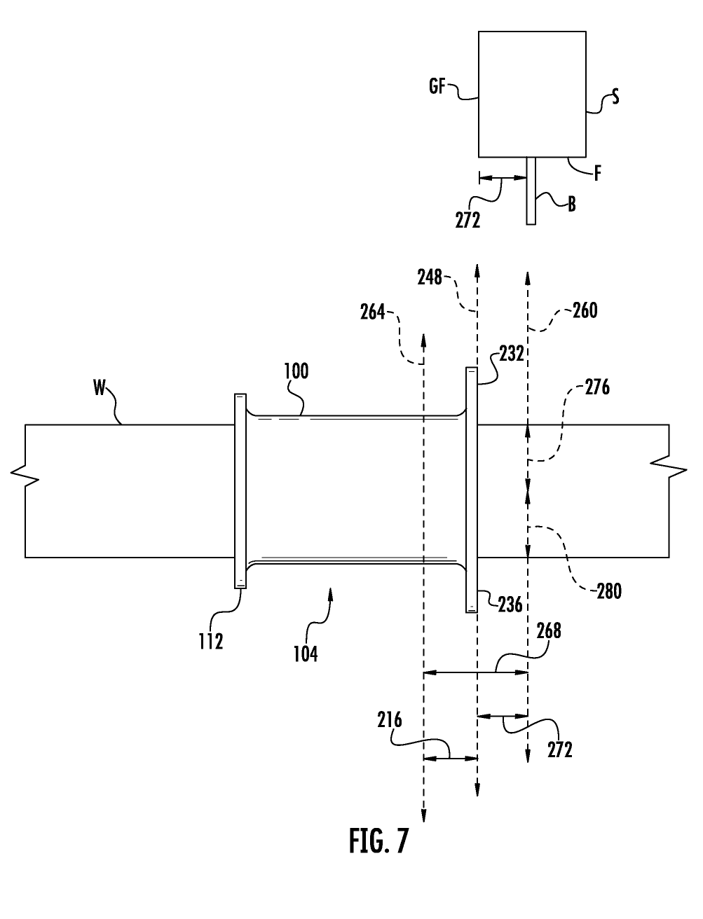

The cuff assembly 104 further includes top alignment openings 208 (FIG. 3) formed in the arm member 120 and bottom alignment openings 212 (FIG. 4) formed in the opposing arm member 124. The alignment openings 208, 212 may be diamond shaped and arranged on the arm member 120, 124 at a predetermined distance 216 from the flange structure 108 and from a guide plane 248 defined by the flange structure 108. The predetermined distance 216 may be shown by the indicia 214 (FIG. 4), which indicates that the alignment openings 208, 212 in the illustrated embodiment are positioned one (1) inch (twenty five (25) millimeters) from the flange structure 108. The alignment openings 208, 212 are used to position the tool guide 100 in relation to a cut path 260 (FIG. 7), as described below.

As shown in FIGS. 3 and 4, the cuff assembly 104 may further include clamp indicia 220, 224 that are formed on the arm members 120, 124. The clamp indicia 220, 224 represent a clamping device, such as a “C” clamp hand tool C (FIG. 9) and indicate to a user that the “C” clamp hand tool may be applied to the clamp members 152, 156 to increase the force with which the clamp members are biased against the workpiece W.

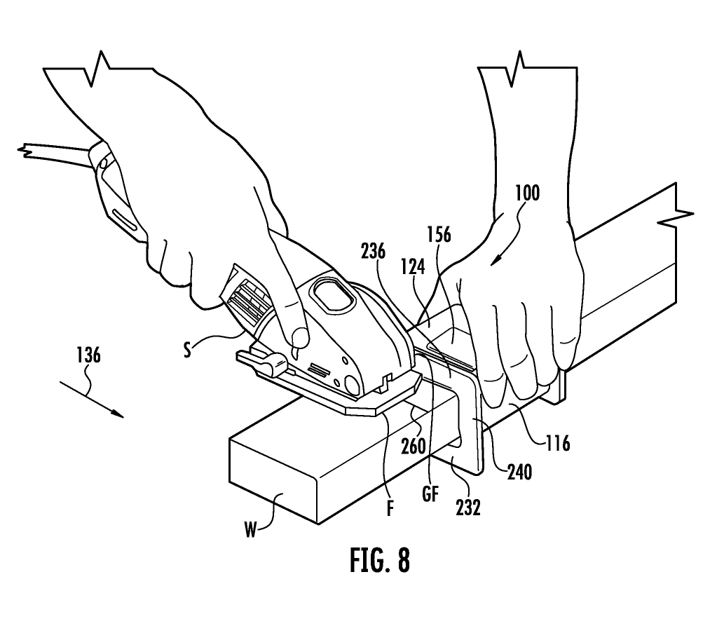

With reference to FIG. 1, the flange structure 108 of the tool guide 100 includes a top flange 232 and a bottom flange 236, which are used to guide a cutting tool, shown as a circular saw S (FIGS. 7 and 8). As shown in FIG. 5, the top flange 232 rigidly extends from the arm member 120 in a first flange direction 244, such that the position of the top flange relative to the arm member 120 is fixed. The top flange 232 defines a guide plane 248 (FIG. 3). Similarly, the bottom flange 236 rigidly extends from the opposing arm member 124 in a second flange direction 252, which is opposite to the first flange direction 244. The position of the bottom flange 236 relative to the opposing arm member 124 is fixed. The bottom flange 236 also falls within the guide plane 248, i.e. the plane defined by the bottom flange 236 is coplanar with the plane defined by the top flange 232.

The flange structure 108 may also include a front flange 240 (FIGS. 1 and 5), which rigidly extends from the body member 116. The front flange 240 further defines and is positioned in the guide plane 248 and, like the flanges 232, 236, may be used to guide the cutting tool S (FIG. 7) through the workpiece W along the cut path 260.

The tool guide 100 may include a support structure 112 extending from the body member 116, the arm member 120, and the opposing arm member 124. The support structure 112 adds rigidity to the cuff assembly 104 and prevents the arm member 120 from moving significantly in the direction 244 and the arm member 124 from moving significantly in the direction 252 as the workpiece W is inserted into the workpiece channel 148.

The tool guide 100 may be formed from injection molded thermoplastic or from another suitable and durable material, as desired by those of ordinary skill in the art. In particular, the tool guide 100 may be formed in a one-shot molding process; accordingly, the tool guide and each of its components may be a monolithic assembly.

In operation, the tool guide 100 assists a user in guiding a cutting tool, such as a circular saw, along a cut path through a workpiece. With reference to FIGS. 7 and 8, the tool guide 100 is shown positioned on a workpiece W along with an exemplary circular saw S. The workpiece W may be a section of construction lumber having dimensions, which are referred to as 2×4, 2×6, or 2×8, among others. To use the tool guide 100, a user marks the position of a cut path 260 (also shown in FIG. 8) on the workpiece W, which represents the desired path through the workpiece to be taken by the blade B of the circular saw S. Next, the user marks an alignment position 264 on the workpiece W that is located a predetermined distance 268 from the cut path.

After the workpiece W is marked up, the user positions a portion of the workpiece in the workpiece channel 148. Since the tool guide 100 is open on the end opposite the body member 116, a user can slide the tool guide onto any lateral position of the workpiece W. As the tool guide 100 is slid onto the workpiece W, the bevel surfaces 166, 190 contact the workpiece W and the upper clamp member 152 and the lower clamp member 156 move to the clamped position, which causes the clamp members 152, 156, to apply a clamping force to the workpiece. In particular, the resiliently of the clamp member 152, 156 causes the ribbed surfaces 168, 192 to be pressed against the workpiece W, thereby enabling the tool guide 100 to remain in a fixed position relative to the workpiece without user intervention.

With the workpiece W positioned in the workpiece channel 148, the user slides the tool guide 100 laterally until the alignment position 264 is visible through the top alignment openings 208. In this position, the flange structure 108 is positioned a saw distance 272 from the cut path 260. The saw distance 272 represents the distance between a guide face GF of the circular saw S the saw blade B. The user may apply a clamp member C to the cuff assembly 104 (as in FIG. 9) to further secure the position of the tool guide 100; although, for most cutting tasks, the clamp members 152, 156 provide a clamping force sufficient to maintain the position of the tool guide 100. Additionally, the user may manually press the clamp members 152, 156 toward the workpiece W for additional stability of the tool guide 100.

As shown in FIG. 8, after the tool guide 100 has been laterally positioned on the workpiece W, the guide face GF of the circular saw S is positioned against the top flange 232 and a guide foot F of the saw is positioned against the top of the workpiece W. Then, the circular saw S is moved in the direction 136 while the guide face GF is positioned against the top flange 232, which causes the blade B to be moved through the workpiece W along the cut path 260.

As shown in FIG. 7, the blade B extends through only an upper portion 276 of the workpiece W. To fully cut the workpiece W, the workpiece is flipped over without moving the tool guide 100 relative to the workpiece. Then, the guide face GF of the circular saw S is positioned against the lower flange 236 and the blade B is guided along the cut path 260 through a lower portion 280 of the workpiece W. Since the lower flange 236 and the upper flange 232 are both positioned in the guide plane 248, the second cut is aligned with the first cut and the workpiece W is fully cut after the second pass of the saw S. The front flange 240 may also be used in a similar manner to make a cut along the cut path 260.

Embodiments of the tool guide 100 without the alignment openings 208, 212 may be positioned on the workpiece W in a similar manner. First, the workpiece W is positioned in the workpiece channel 148. Then, the blade B of the saw S is aligned with the cut path 260 and the tool guide 100 is moved toward the saw until the flange structure 108 contacts the guide face GF. Thereafter, the user guides the saw S along the flange structure 108, as described above.

In another embodiment, the cuff assembly 104 includes additional pairs of the alignment openings (not shown) formed in at least one of the arm member 120 and the opposing arm member 124. The pairs of additional alignment openings are each positioned a corresponding predetermined distance from the flange structure 108 and from the guide plane 248. For example, the cuff assembly 104 may include pairs of the alignment openings positioned at one half (½) inch (thirteen (13) millimeters), one (1) inch (twenty five (25) millimeters), and two (2) inches (fifty (50) millimeters) from the flange structure 108.

FIG. 9 illustrates another embodiment of the tool guide 100′. The tool guide 100′ includes all the elements of the tool guide 100 and functions in substantially the same manner, except that the tool guide 100′ does not include the clamp members 152, 156. Instead, the tool guide 100′ includes ribs 284′ formed in the arm member 124′ and ribs (not shown) formed in the arm member 120′. The ribs 284′ extend into the workpiece cavity 148 and grip the workpiece W. The clamp C may be applied to the tool guide 100′ to further secure the position of the tool guide 100′ relative to the workpiece W.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A tool guide for guiding a cutting tool comprising:
a cuff assembly including a body member, an arm member extending from said body member, and an opposing arm member extending from said body member, said body member, said arm member, and said opposing arm member configured to define a workpiece channel;
a first resilient clamp member configured to extend from said arm member into said workpiece channel; and
a second resilient clamp member configured to extend from said opposing arm member into said workpiece channel.

2. The tool guide of claim 1, wherein:
said first resilient clamp member includes a first ribbed surface facing said second resilient clamp member, and
said second resilient clamp member includes a second ribbed surface facing said first resilient clamp member.

3. The tool guide of claim 1 further comprising a support structure extending from said cuff assembly.

4. The tool guide of claim 1 further comprising:
a first flange extending from said arm member; and
a second flange extending from said opposing arm member.

5. The tool guide of claim 4, wherein:
said first flange defines a first guide plane,
said second flange defines a second guide plane, and
said first guide plane is coplanar with said second guide plane.

6. The tool guide of claim 4, wherein said arm member includes an alignment opening positioned a predetermined distance from said first flange.

7. The tool guide of claim 1, wherein:
said arm member and said first resilient clamp member are configured as a first monolithic assembly, and
said opposing arm member and said second resilient clamp member are configured a second monolithic assembly.

8. A tool guide for guiding a cutting tool relative to a workpiece comprising:
a body member defining a first edge located in an edge plane;
an arm member extending from said body member, said arm member defining a second edge located in said edge plane;
an opposing arm member extending from said body member, (i) said opposing arm member defining a third edge located in said edge plane and (ii) said body member, said arm member, and said opposing arm member defining a workpiece channel configured to receive the workpiece;
a first flange extending away from said second edge; and
a second flange extending away from said third edge.

9. The tool guide of claim 8, wherein:
said arm member extends from said body member in only a first direction, and
said opposing arm member extends from said body member in only said first direction.

10. The tool guide of claim 9, wherein:
said first flange extends away from said second edge in a second direction,
said second flange extends away from said third edge in a third direction, and
said second direction is opposite to said third direction.

11. The tool guide of claim 8, further comprising:
a first resilient clamp member configured to extend from said arm member into said workpiece channel; and
a second resilient clamp member configured to extend from said opposing arm member into said workpiece channel.

12. The tool guide of claim 11, wherein a first distance extending between said first resilient clamp member and said second resilient clamp member when said workpiece is positioned in said workpiece channel is greater than a second distance extending between said first resilient clamp member and said second resilient clamp member when said workpiece channel is void of said workpiece.

13. The tool guide of claim 8, wherein:
said arm member includes a first alignment opening positioned a predetermined distance from said first flange, and
said opposing arm member includes a second alignment opening positioned said predetermined distance from said second flange.

14. A tool guide for guiding a cutting tool relative to a workpiece comprising:
a body member;
an arm member extending from said body member in a first direction;
an opposing arm member extending from said body member in said first direction, said body member, said arm member, and said opposing arm member defining a workpiece channel configured to receive the workpiece;
a first flange extending from said arm member in a second direction; and
a second flange extending from said opposing arm member in a third direction opposite to said second direction.

15. The tool guide of claim 14, wherein:
said first flange defines a first guide plane,
said second flange defines a second guide plane, and
said first guide plane is coplanar with said second guide plane.

16. The tool guide of claim 14, further comprising a support structure extending from said body member, said arm member, and said opposing arm member.

17. The tool guide of claim 14, further comprising:
a first clamp member configured to extend from said arm member toward said opposing arm member; and
a second clamp member configured to extend from said opposing arm member toward said arm member.

18. The tool guide of claim 17, wherein:
said first clamp member resiliently extends from said arm member, and
said second clamp member resiliently extends from said opposing arm member.
